(19) United States
(12) Patent Application Publication
(10) Pub. No.: US 2026/0188580 A1
(43) Pub. Date: Jul. 2, 2026

(54) Rapid Solution Combustion Synthesis of Highly Ordered Porous Metal Oxide Layers

(71) Applicant: The Board of Trustees of the Leland Stanford Junior University, Stanford, CA (US)

(72) Inventors: Thomas W. Colburn, Redwood City, CA (US); David W. Collinson, Auckland (NZ); Reinhold H. Dauskardt, Menlo Park, CA (US)

(21) Appl. No.: 19/217,877

(22) Filed: May 23, 2025

Related U.S. Application Data
(63) Continuation-in-part of application No. PCT/US2024/022868, filed on Apr. 3, 2024.
(60) Provisional application No. 63/456,701, filed on Apr. 3, 2023.
(60) Provisional application No. 63/651,832, filed on May 24, 2024.

(51) Int. Cl. H01G 4/22; H01G 4/20; H01G 4/33; H01G 13/04

(52) U.S. Cl. CPC H01G 4/221; H01G 4/206; H01G 4/33; H01G 13/04

(57) ABSTRACT

Fabrication of highly ordered metal oxide layers is performed by combining deposition of an oxidant-containing precursor, a pore-generating precursor, and a metal-containing precursor, depositing the precursor, and combustion of the precursor to form a metal oxide layer. In one example, high-quality porous aluminum oxide layers with controlled, 7 nm ordered porosity is demonstrated.

Embodiments of the invention also include forming a polymer-filled porous metal oxide composite to serve as an improved capacitor dielectric.

### CROSS REFERENCE TO RELATED APPLICATIONS

This application claims the benefit of U.S. provisional patent application 63/651,832, filed on May 24, 2024, and hereby incorporated by reference in its entirety.

This application is a continuation in part of international application PCT/US2024/022868, filed on Apr. 3, 2024 and hereby incorporated by reference in its entirety.

International application PCT/US2024/022868 claims the benefit of U.S. provisional patent application 63/456,701, filed on Apr. 3, 2023, and hereby incorporated by reference in its entirety.

### GOVERNMENT SPONSORSHIP

This invention was made with Government support under contract FA9550-21-1-0070 awarded by the Air Force Office of Scientific Research. The Government has certain rights in the invention.

### FIELD OF THE INVENTION

This invention relates to fabrication of porous metal oxide layers and then filling the pores in such layers with a polymer to form a capacitor dielectric.

### BACKGROUND

Highly ordered, mesoporous thin film oxides are a sought-after class of materials due to their high surface area, functionalizable pore walls, and controllable pore volume. Mesoporous oxides have been used for optoelectronics, sensing, dielectrics, batteries, and catalysis. The ability to fill the metal oxide porosity with various polymers, small molecules, or use the oxide as an etchable template has given rise to unique and tunable nanostructures.

In particular, extensive research has been performed on leveraging sol-gel processes to develop mesoporosity in thin films of silica and alumina. These research efforts have also focused on control of the rates of hydrolysis and condensation to affect film structure and the modification of the porogen to affect the oxide film properties. Intrinsic limitations of throughput, cost, and precursor stability, however, have greatly limited their manufacturing potential via sol-gel.

The typical fabrication process for porous, thin film oxides involves a multi-step formation process where the sol is first aged in the presence of an acid or base at very high or low pH along with a polymeric porogen to form sol particles which are deposited via a solution method like spin coating. The porogen polymers form micelles based on their hydrophilic and hydrophobic moieties in the drying film driven by evaporation-induced self-assembly (EISA). During the assembly process, the highly polar metal sol precursor containing metal hydroxide groups affiliates to the hydrophilic corona of the micelle leaving the hydrophobic core free of metal species. The films are then slowly dried under controlled relative humidity and temperature to drive further hydrolysis and subsequential condensation processes. High temperatures at incremental ramp rates are used to drive condensation to competition, metal oxide network densification, and porogen removal.

Because of the use of a sol-gel process, however, the current state-of-the-art mesoporous thin film methods struggle from a number of critical drawbacks which predominately affect manufacturability. Firstly, the precursor sol and films during aging are highly sensitive to temperature, relative humidity, and pH. As a result, the successful deposition demands exacting control of solution fabrication and aging steps during which hydrolysis and condensation progress. These aging steps can last approximately four hours with dependency on the hydrolysis rate of the metal cation and be sensitive to small perturbations in humidity of ±10% RH. Secondly, the metal alkoxides that are often used in sol-gel methods are expensive relative to their inorganic salt counterparts and highly prone to degradation and hydrolysis over time. Thirdly, the high temperatures used to densify the oxide and burn out the porogen makes for highly energy-intensive processes lasting often upwards of 12 hrs. Finally, the processing conditions together typically demand upwards of three days of processing time when combining the controlled aging steps and slow thermal ramps to high curing temperatures. As such, the combination of low-throughput, high energy, and high environmental sensitivity make mass production of mesoporous metal oxide thin films prohibitively difficult for implementation at a larger scales and lower costs.

Accordingly, it would advance the state of the art to develop new methods of generating layers of ordered porous metal oxides.

### SUMMARY

Solution combustion synthesis (SCS) is a next-generation method of generating metal oxide powders at substantially reduced process temperatures (often <300° C.) and with the potential to use green, affordable precursors. The metal oxide is typically produced from a mixture of a metal nitrate, which acts as both the metal source and oxidant, and an organic fuel which is also a chelator to the metal species. Ideally, the organic chelating fuel acts to both inhibit premature hydrolysis and gelation of the solution as well as to participate in the exothermic redox reaction that results in the desired metal oxide. The combustion reaction has a significantly higher reaction enthalpy than sol-gel processes and generates substantial heat allowing the reaction to be self-sustaining.

Due to the need to generate a manufacturable method for producing large areas of thin film mesoporous oxides (here and throughout this work, “thin film”, “layer” and “coating” are regarded as synonyms) at reduced fabrication costs, with less demanding process controls, and with higher throughputs, we consider in detail below an example where a combination of EISA to form mesoporosity with SCS generates the metal oxide in a highly rapid, low-cost process.

In the process described, a metal source, oxidant, pore generating molecule, and organic chelating agent are combined to generate ordered nanoporous layers. When deposited, the solvent is evaporated from the film during which the pore generating molecules self-assemble into micelles with the metal species and oxidant affiliating into the outer hydrophilic moiety of the micelle. After assembly, the films are dried of their solvent and heated to above the ignition temperature at which point the rapid oxidation process between the oxidant, pore-generating molecule, and complexing agent occurs.

In some examples of this work, we have developed an approach utilizing solution combustion oxidation to produce highly ordered, porous (0.1-100 nm), metal oxide thin films rapidly from low-cost, available metal salts, complexing reagents, and an amphiphilic polymer that self assembles to micelles and often forms complexes with the added metal salts. The polymer serves both as a templating species for structure formation in the film and as a fuel source for the exothermic reaction. Here we term this process Porogen Integrated Rapid Oxidation (PIRO). The structure in the film is produced via evaporation induced self-assembly upon casting.

The initial step in this exemplary process involves making a solution in either a polar hydrogen bonding or dipolar aprotic solvent (e.g., ethanol, 2-methoxyethanol, water, dimethoxyethane, 1-butanol, etc.) . The solution includes a metal salt, a porogen, a polar chelating molecule which also serves as a fuel for combustion, a pH-regulating base and a nonvolatile oxidant. The preferred embodiment is a metal nitrate salt (e.g., nickel nitrate, aluminum nitrate, zinc nitrate, etc.) which can serve as both the metal oxide source and the nonvolatile oxidant. For metals that do not form stable nitrates (e.g., tin), an external oxidant such as ammonium nitrate, nitric acid, perchlorate salts, etc. can be added. The chelating species can be metal complexing reagents such as acetylacetone, citric acid, malic acid, hydroxyglutaric acid, tartaric acid, etc.

Multiple metal precursors can be used simultaneously to produce a mixed metal oxide film. Additionally, other nonvolatile oxidants such as perchlorates, peroxydisulfates, peroxides, superoxides, and permanganates can be used as the oxidant source. Some specific examples of the porous films that can result from the outlined method are described below.

In these examples, diglyme, glycolic acid, diglycolic acid, or malic acid was added to a solution of metal nitrate in anhydrous ethanol, followed by the addition of aqueous ammonia to adjust the pH and drive complexation. The solution is then stirred for 1 hour before the amphiphilic polymer porogen (e.g., Pluronic@ F127) is added. This solution is allowed to stir for 1-2 hours before deposition via spin coating. After deposition, the films are first aged under ambient conditions for 10-60 min to promote self-assembly and subsequently heated in an oven at a temperature above room temperature but below the ignition temperature (T_{ignition}) to remove solvent for an additional 10-60 min. The final curing, which results in the oxidative reaction, occurs at T≥T_{ignition} on a hotplate in air. Heating the film above the sample ignition temperature simultaneously results in both the formation and consolidation of the metal oxide network and removal of the polymer structuring agent. The resulting porous metal oxide films prepared as described are ready for incorporation into devices for applications.

The use of a metal complexing porogen provides multiple beneficial effects. This polymer serves as a structuring agent resulting in a highly ordered porous network, can (optionally) serve as a potential chelation agent to complex with metal ions prior to rapid oxidation, and finally can provide a fuel source to promote the rapid oxidation. The exothermic oxidation reaction occurs after deposition/structuring of the film and results in both the formation of the metal oxide and the removal of the porogen structuring agent in a single step. The rapid oxidation step delivers a key processing advantage over other competing technologies by decreasing processing temperature and time. The polymer used in these examples produces pore sizes on the order of 5-15 nm depending on the oxide composition. While these pores have typical sizes for the described process, these can be varied by changes in porogen structure and molecular weight. In addition, the choice of solvent and processing conditions can also be modified to influence the pore structure and size. We expect that control of the porogen species allows for access to pores that range in size from 0.5-100 nm. Further, although the thin films of these examples have thicknesses on the order of 200-500 nm, tuning the deposition process and solution concentrations can produce films with thicknesses ranging from <10 nm to a few microns.

For the structuring agent, we have chosen non-ionic amphiphilic materials ideally, but not exclusively, including block copolymers containing hydrophobic and hydrophilic segments. A key feature for the ideal porogen is a hydrophilic segment that has chemical units capable of interacting with the metal cations (e.g., polyethers such as polyethylene oxide, poly-acrylic acids, hydroxyethyl methacrylates, acrylamides, etc.). Examples of commercial amphiphilic non-ionic surfactants that can be used include Pluronic® (BASF) and Brij surfactants, Dowfax nonionic surfactants, etc. Another important component is the polyfunctional chelator (e.g., diglycolic acid or malic acid) that is included in sufficient concentration to stabilize the solution and inhibit premature hydrolysis and hydroxide/oxide precipitation. After the solution is deposited as a thin film, the polyfunctional chelator also mediates the subsequent hydrolysis and condensation of the metal salt such that the self-assembly of film structure can occur. Additionally, the chelating agent also acts as a secondary fuel source. The final component of the solution is the base, which is included to adjust the pH of the solution to drive complexation of the metal ions with the carboxylic acid and the polymer structuring agent. Although we have observed rapid oxidation (from thermal analysis) in samples not containing any added base, the adjustment of pH usually leads to a more generally reproducible process.

The solution can be deposited on substrates using a variety of techniques, with specific examples including spin coating, blade coating, and ultrasonic spray deposition resulting in films that are typically 100s of nm thick. We also anticipate other deposition methods such as dip coating, meniscus coating, slot-die coating, etc. to be viable deposition approaches.

Advantages over sol-gel methods to generate ordered nanoporosity: Sol-gel processing generally requires fine-tuned control over environmental parameters (e.g., humidity), expensive alkoxide precursors, long aging times, and energy-intensive, multi-hour annealing steps to generate ordered porosity via EISA. Large area devices are difficult to achieve due to the need to maintain the environmental conditions across the processing area. Our preferred embodiment of ordered porous layers of aluminum oxide can be generated with as little as 1 minute of drying, 1 minute of aging, and 1 minute of flash annealing using a near-infrared curing system. Additionally, our preferred embodiment uses inexpensive nitrates and small molecule co-fuel complexing agents.

Advantages over nanoparticle sintering strategies: Porous films can be generated via nanoparticle sintering to yield interconnected porosity in the void space of the sintered particles. This method, however, requires high temperatures and often long annealing times to drive sintering processes rendering it incompatible with many flexible substrates. The oxide generated by this method is often disorganized and lacks the ordered structure observed in our preferred embodiment. In this alumina layer example, the thin films are generated at temperatures <250° C. in as little as 1 minute. Compatibility with flexible substrates including on polyimide is demonstrated. Furthermore, X-ray scattering demonstrates ordering of the porosity generated via the preferred embodiment through the bulk. The degree of ordering can be further controlled by the chemical identity of the organic ligand added in solution.

Due to the low temperatures required for formation of the porous oxide matrix, the flexibility in the composition of the metal oxide materials, and the ability to control the pore sizes and architectures, we see this technology having the potential to impact many commercial applications. We expect that chemical, optical, photonic, electrical, and biological fields can benefit from availability of highly ordered, scalable porous films for applications such as gas/liquid sensors (e.g., detection of toxins/pathogens, gas mixture analysis, including sensors/biosensors utilizing size selection, catalysis (e.g., transformation of CO₂, etc.), optoelectronics (e.g., up/down conversion material scaffolds and solar cell hole/electron transport layers), anti-reflective coatings, graded index photonics, dielectric materials both filled and unfilled, (e.g., capacitors or low-k dielectrics, ionic supercapacitors), semipermeable membranes, thermal barrier layers, drug delivery, etc.

### BRIEF DESCRIPTION OF THE DRAWINGS

FIGS. 1A-C schematically show an exemplary embodiment of the invention.

FIGS. 2A-D show combustion characterization experimental results.

FIGS. 3A-D show characterization results on the effect of adding ammonia.

FIGS. 3E-G are SEM images relating to the effect of adding ammonia.

FIGS. 4A-H are small angle x-ray diffraction and SEM results showing the effect of various small-molecule species on the order of the porosity in the porous metal oxide layers.

FIG. 5A schematically shows spray deposition.

FIG. 5B is an optical image of a spray deposited layer.

FIG. 5C schematically shows blade deposition.

FIG. 5D is an optical image of a blade deposited layer.

FIGS. 5E-G are SEM images of several blade-deposited porous metal oxide layers.

FIGS. 5H-J are XPS results comparing several different deposition configurations.

FIG. 5K shows optical spectroscopy results comparing two different substrate configurations.

FIGS. 6A-D are optical and SEM images of two spin-deposited porous metal oxide layers.

FIGS. 7A-B schematically show filling of pores of a porous metal-oxide layer to form a capacitor dielectric.

FIGS. 8A-B show characterization results of porous metal-oxide layers having significant pore periodicity.

FIGS. 9A-B show exemplary characterization results of polymer-filled porous metal-oxide layers.

FIGS. 10A-B show electrical characterization results of a polymer-filled porous metal-oxide layer.

FIG. 10C shows fracture energy and layer thickness vs. aging time for a polymer-filled porous metal-oxide layer.

### DETAILED DESCRIPTION

Section A describes general principles relating to embodiments of the invention. Section B describes several detailed examples relating to this work. Section C describes an application of this work to making capacitor dielectrics.

### A) GENERAL PRINCIPLES

An exemplary embodiment of the invention is a method of making a porous metal oxide layer, the method comprising:
depositing a solution onto a substrate to provide a deposited layer, wherein the solution includes a nonvolatile oxidizing reagent, a porogen, and one or more metal ion complexes of one or more metallic species;
aging the deposited layer to perform self-assembly in the deposited layer, wherein the structured, self-assembled layer is generated having a structure determined in part by the porogen; and
oxidizing the structured, self-assembled layer to form the porous metal oxide layer via a rapid, local, exothermic oxidation reaction that provides decomposition of the porogen.
   Here pores of the porous metal oxide layer are formed by decomposition of the porogen in the oxidizing step, and the porous metal oxide layer has a pore structure corresponding to the structure of the structured self-assembled layer.

Optionally the structured, self-assembled layer can be dried at a temperature at or above ambient and below a metal oxidation ignition temperature to remove excess solvent, thereby providing a consolidated dried layer. Such drying can be performed for a duration between 10 minutes and 120 minutes. Some solvents can be sufficiently removed by aging at ambient temperature, while other solvents require a separate drying step.

Preferably, decomposition of the porogen occurs after the film has consolidated during the oxidizing such that porosity is supported without pore collapse due to capillary forces.

The porogen can include a molecular species containing hydrophobic and hydrophilic constituents. In this case, the hydrophilic constituents of the porogen preferably include chemical units capable of interacting with cations of one or more metallic species.

The solution can include a metal oxidant salt acting as both a metal source and as the nonvolatile oxidant.

The solution can include an oxidant and a metal non-oxidant salt acting as the metal source for the oxide.

The solution can include one or more additional components such as: metal salts, polar hydrogen bonding solvents, dipolar aprotic solvents, polar chelating fuel species, and pH-regulating species. If present, the polar chelating fuel species can be included in sufficient concentration to perform one or more functions such as: stabilizing the solution, inhibiting premature hydrolysis, inhibiting hydroxide/oxide precipitation, and affecting the structure of the structured, self-assembled layer.

Practice of the invention does not depend critically on how the solution is deposited. Suitable deposition methods include, but are not limited to: ultrasonic spray deposition, blade coating, slot-die coating, spin coating, meniscus deposition, ink jet printing and gravure printing. Preferably, deposition is performed by moving a nozzle or the like over the substrate at a speed of 1 mm/s or more, and more preferably at a speed of 10 cm/s or more. As an example, the solution for ultrasonic deposition can be injected via syringe pump through an ultrasonic oscillating nozzle tip. The resulting droplets formed are deposited on the film as the nozzle moves across the substrate at speeds of approximately ≥21 mm/s (more preferably 10 cm/s or more).

The aging can be performed for a duration between 1 minute and 60 minutes.

Pores of the porous metal oxide layer can have pore sizes in a range from 0.1 nm to 100 nm.

The thickness of the metal oxide layer can be in a range from 10 nm to 5 μm.

Self-assembly can be performed in various ways, including but not limited to: evaporation induced self-assembly, solvent induced self-assembly, temperature induced self-assembly, surface induced self-assembly and electrochemically induced self-assembly.

Practice of the invention does not depend critically on the substrate. Suitable substrates include, but are not limited to: quartz, glass, UV and/or ozone treated glass, metals, metal oxides, polymers and polar surfaces. The substrate can be rigid or flexible.

The solution includes metallic species corresponding to the metal oxide to be grown (both for composition and doping), oxidants, a pore generating molecule, and an organic ligand fuel which can include the pore generating molecule. Subject to these conditions, practice of the invention does not depend critically on specific reagents or the like. In the following, several examples for each solution constituent are given

Suitable metallic elements for inclusion in the solution (e. g., as oxidant or non-oxidant metal salts) include, but are not limited to: Li, Na, Mg, Al, K, Ti, Co, Ni, Cu, Zn, Ga, Zr, Cd, In, Sn, Ba, La, Hf and Ta.

Suitable oxidants for inclusion in the solution include, but are not limited to: nitrates, chlorites, chlorates, perchlorates, hypochlorites, peroxydisulfates, peroxymonosulfates.

The metal ions can principally be derived from metal nitrates along with organic metal salts (i.e., citrates, lactates, acetylacetonates). Additionally, polar soluble materials such as metal chlorides, acetates, oxynitrates, fluorides, sulfates and organo-ligated complexes (i.e. oxalate, malonate, propoxide) can be utilized. When a non-nitrate metal ion source is used, subsequent nitrate oxidant sources can be introduced to the solution such as ammonium nitrate, organic amine nitrate salts, or quaternary ammonium nitrates (e. g. tetramethyl ammonium nitrate, etc.).

Suitable metallic non-oxidant salt species for inclusion in the solution include, but are not limited to: metal acetylacetonate salts, metal chlorides, metal acetates, metal oxynitrates, metal fluorides, metal sulfates, metallic organo-ligated complexes, metal oxalates, and metal alkoxides.

Suitable non-metallic oxidant salt species for inclusion in the solution include, but are not limited to: ammonium nitrate, organic amine nitrate salts, quaternary ammonium nitrates, tetramethyl ammonium nitrate, chlorites, chlorates, perchlorates, hypochlorites, peroxydisulfates, and peroxymonosulfates.

Suitable non-metallic non-salt oxidant species for inclusion in the solution include, but are not limited to: nitric acid, peroxydisulfuric acids, peroxymonosulfuric acids, peracids, aliphatic or aromatic organic nitro compounds, nitrobenzene, nitropropane, nitroethane, nitrous oxides, peroxide-containing organic species, peroxides, and hydroperoxides.

The pore generating molecule, herein called the porogen, preferably acts as a templating agent for the formation of porosity with variable size along with potential to act as a fuel in the combustion process.

Suitable porogens include di- and tri-block amphiphilic co-polymers as well as cationic, anionic, nonionic, and zwitterionic surfactants that form micelles including a hydrophilic and hydrophobic group. These hydrophilic groups can include but are not limited to: polyethylene oxide, polyamides, polyamines, polyamides, polyimines. These hydrophobic groups can include but are not limited to: polypropylene oxide, polystyrene, poly(methyl methacrylate), chitosan, aliphatic carbon chains, polylactides.

If present in the solution, the organic complexing fuel species preferably acts as a metal complexing ligand to assist in the ordering of the micelles into closed-packed structures, mitigate metal hydroxide formation in the solution and/or oxide premature condensation, and to promote solubility of metallic species in organic solvents. Ideally, the organic complexing fuel species should serve both as a metal complexing ligand to prevent volatilization and promote solubility in organic solvents and as a fuel for the oxidative combustion, where localized exothermicity drives the formation of the metal oxide films. Combustible ligands usually contain carbon and hydrogen, but may contain other elements as well which support or enhance the combustion process. To serve as a fuel, these materials should be combustible in the presence of an oxidizing agent such as nitrate ions, organic nitrates, nitrites, nitro derivatives. These examples are meant to be representative rather than comprehensive. Furthermore, solvent/fuel combinations such as oxidizing/oxidizable species like nitrobenzene, nitropropane, and nitroethane can be considered as possible oxidizing/fuel sources that also solubilize the metal salts.

Suitable complexing compounds for inclusion in the solution include, but are not limited to: alcohols, ketones, aldehydes, carboxylic acids, esters, ethers, oximes, hydroxamic acids, diols, polyols, polyfunctional ethers, dimethoxyethane, polyethylene glycols, alpha and beta hydroxy aldehydes, beta diketones, beta keto esters, beta keto acids, and oxylates.

Suitable oxidizing species for inclusion in the solution include, but are not limited to: aromatic organic nitro compounds, aliphatic organic nitro compounds, nitroacetylacetone, nitro carboxylic acids, organic peroxides, organic hydroperoxides, and organic peracids. Oxygen for the thin-film metal oxide can comes in part from oxidizing species that are part of the organic complexing fuel species.

### B) DETAILED EXAMPLES

The following results describe the various aspects of the chemistry, processing and structure of the developed approach to produce structured, mesoporous, aluminum oxide thin films rapidly at processing temperatures as low as 200° C. Critical aspects including the solution chemistry, and control over the self-assembly of the deposited precursor that enables the low processing temperatures and rapid processing times are presented and discussed. Finally, the compatibility of the process with scalable manufacturing techniques such as doctor blading, ultrasonic spray deposition and near-infrared (NIR) flash annealing is considered. The following description is by way of example, and is not to be construed as limiting any aspect of embodiments of the invention to any of the specifics of these examples.

### B1) Chemistry and Combustion in Bulk and in Thin Film

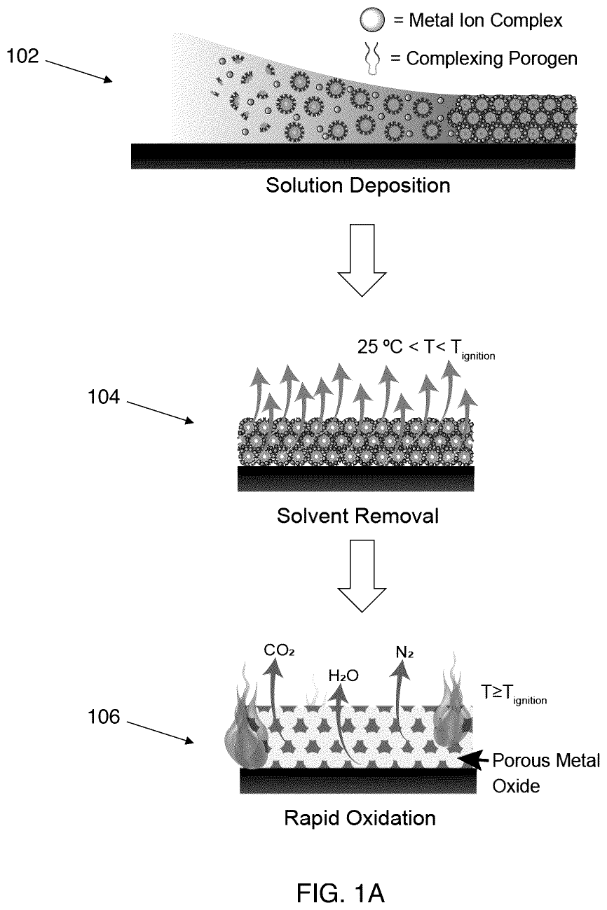

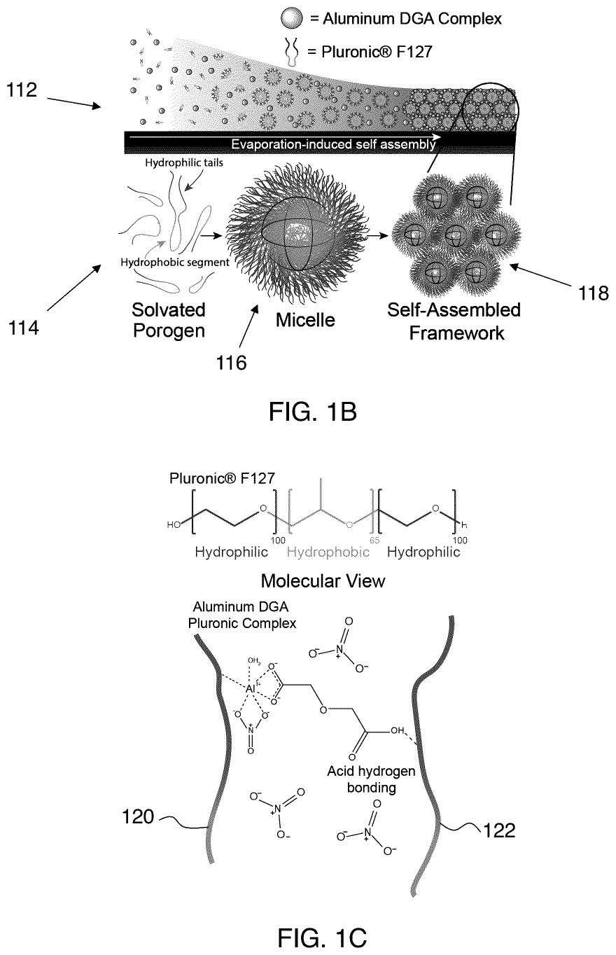

FIGS. 1A-C show aspects of the synthesis approach considered herein. FIG. 1A is an overview of film deposition 102 (including formation processes showing the formation and self-assembly of polymeric micelles), the removal 104 of the deposition solvent, and the redox reaction 106 that simultaneously converts the Aluminum complex to the oxide and burns out the polymer structuring agent. FIG. 1B is a detail showing the self-assembly 112 of the Pluronic@ F127 tri-block co-polymer 114 into the micellar framework 118 including micelles 116. FIG. 1C is a detail showing the proposed bonding environment for the Aluminum complexes involving the nitrate anions, diglycolic acid, and ether oxygens of the PEO (poly(ethylene oxide)) segments 120, 122 in the Pluronic® F127.

We have termed our approach as porogen-integrated rapid oxidation, or PIRO. An overview of the approach is detailed in FIGS. 1A-C. PIRO involves a precursor solution containing: a metal nitrate salt, an organic ligand, and a micelle forming block co-polymer.

At a high level, (FIG. 1A) the process of the film involves three steps, first the precursor solution is deposited by an appropriate deposition technique, then the film is dried (or aged) to remove the solvent, and finally the film is cured through a rapid oxidation process by raising the temperature of the film to the ignition temperature.

The deposition and self-assembly (FIG. 1B) of the amphiphilic block co-polymers into a lattice of ordered micelles has previously been extensively described. The metal cation complexes segregate into the hydrophilic corona to form a lattice structure at room temperature in standard atmospheric conditions.

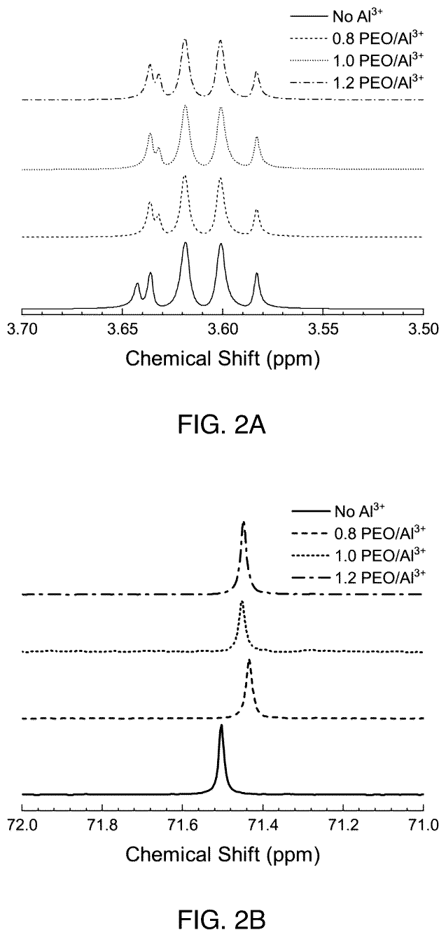

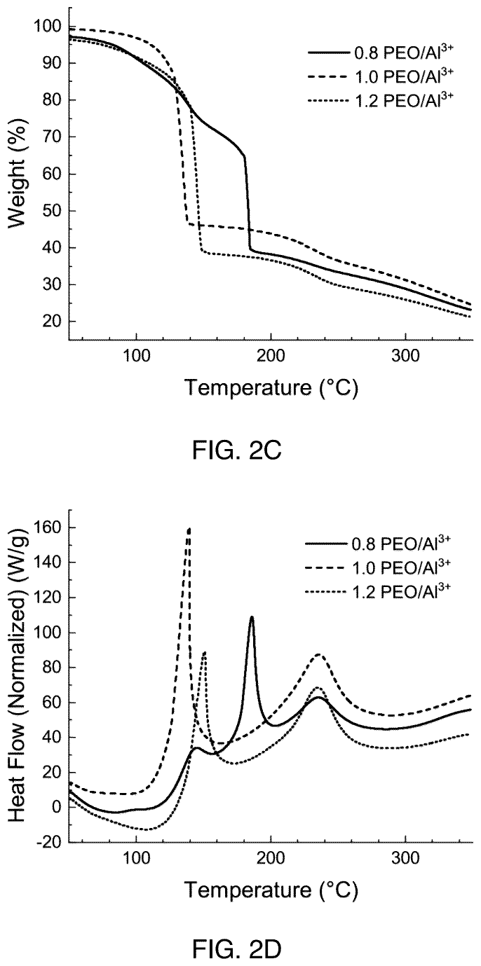

FIG. 2A is a ¹H NMR of the F127. Solutions containing Al(NO₃)₃ show a downshift of the PEO-block F127 protons relative to the protons of the PEO in F127 in ethanol without Al(NO₃)₃. FIG. 2B is a ¹³C NMR of the ether carbon of the PEO unit in the Pluronic® F127. Addition of Al(NO₃)₃ results in a downshift of the ether carbon. For NMR measurements, solutions not containing Al(NO₃)₃ are adjusted with dilute HNO₃ to an equivalent pH and water content. FIG. 2C shows TGA (thermogravimetric analysis) and FIG. 2D shows DSC (differential scanning calorimetry) of dried precursor powders with different amounts of F127, both figures showing the sudden mass loss and strongly exothermic peak between 120° C. and 200° C.

The precursor solution can be reacted under heating to encourage the coordination of the metal cation to the PEO-block of the polymer. (FIG. 1C) For the case outlined in this second utilizing Al(NO₃)₃·9H₂O, the Al³⁺ cation will coordinate to the ether oxygens comprising the PEO block after an appropriate rection time (FIGS. 2A-B). Coordination of the Al³⁺ to the PEO acts to slow undesirable hydrolysis reactions in solution and, when deposited, allows for self-assembly of the polymer-complex system to occur. An additional organic ligand can also be included in the precursor solution to tune the self-assembly and aid the formation of a specific space group. The impact of organic ligands on the self-assembly of the mesoporous structure will be examined further below.

¹H (FIG. 2A) and ¹³C (FIG. 2B) NMR of Al(NO₃)₃·9H₂O and Pluronic® F127 in an Ethanol/Methanol-d4 mixture show a distinct downshift in the peak position for the ether carbon of the Pluronic® F127 when Al(NO₃)₃·9H₂O is included in the solution relative to a control solution. The control solution does not include Al(NO₃)₃·9H₂O, but is adjusted with dilute HNO₃ to an equivalent pH and H₂O content. The downshift suggests a less electronegative environment for the PEO, consistent with the proximity of the highly charged Al³⁺ cation to the PEO segments. Decreasing the molar concentration of the Pluronic® relative to the Al³⁺ results in a small additional downshift of the PEO peak position as a larger fraction of the PEO in solution is ligating Al³⁺.

Combined TGA (FIG. 2C) and DSC (FIG. 2D) of powders dried from solutions shows an increase in the combustion temperature from 139° C. to 150.6° C. as well as a decrease in the enthalpy of the combustion from 10.1 KJ/g to 6.3 KJ/g as the molar ratio of PEO to Al³⁺ is increased from 1 to 1.2.

Modifying the molar concentration of PEO relative to aluminum nitrate directly influences the combustion fuel/oxidant ratio and can yield fuel rich conditions with excess PEO, fuel lean conditions with excess nitrate, or fuel balanced conditions with equal quantity of PEO and nitrate available for participation in combustion. Increased PEO content in the 1.2 molar ratio sample shows a reduced overall combustion heat flow and suppressed reaction temperature. Additionally, the second exothermic peak associated with the decomposition of the carbonaceous residues shows increased intensity relative to the main combustion peak in the 1.2 molar ratio specimen versus the 1 molar ratio combustion. This increased influence of the second peak is demonstrative of a fuel-rich configuration.

In contrast, reducing the PEO block concentration by decreasing the PEO molar ratio from 1 and 0.8 suggests a fuel lean situation. For the 0.8 molar ratio of PEO to Al³⁺, there are three exothermic peaks; one peak indicates the degradation of the precursor before combustion can occur followed by the combustion event and subsequent degradation of the carbonaceous residues. The third carbon residue degradation peak is much smaller in relative exothermicity in the 0.8 molar ratio specimen compared with the 1 molar ratio sample owing to the reduced PEO in the reaction yielding less combustible carbon.

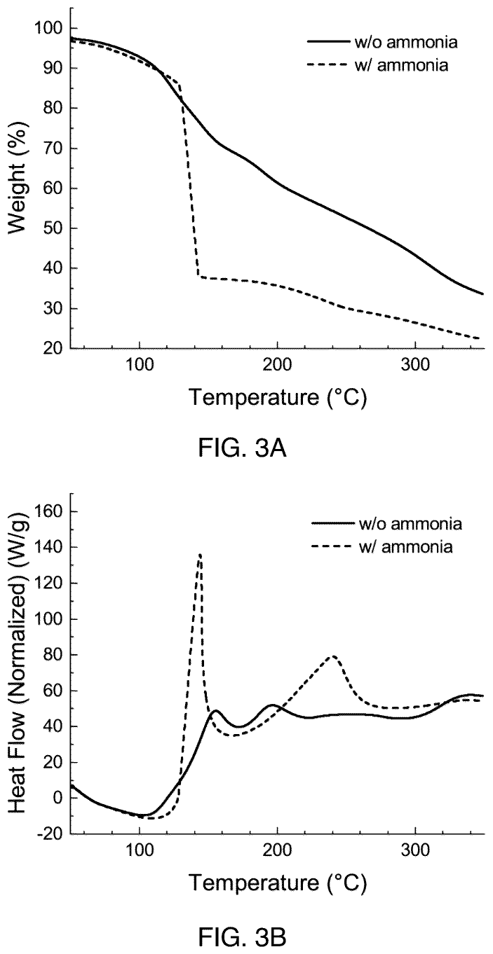

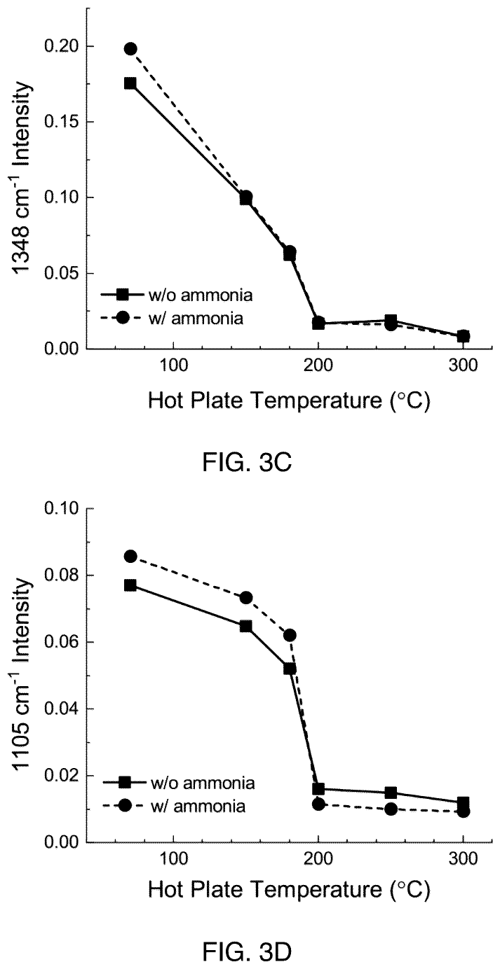

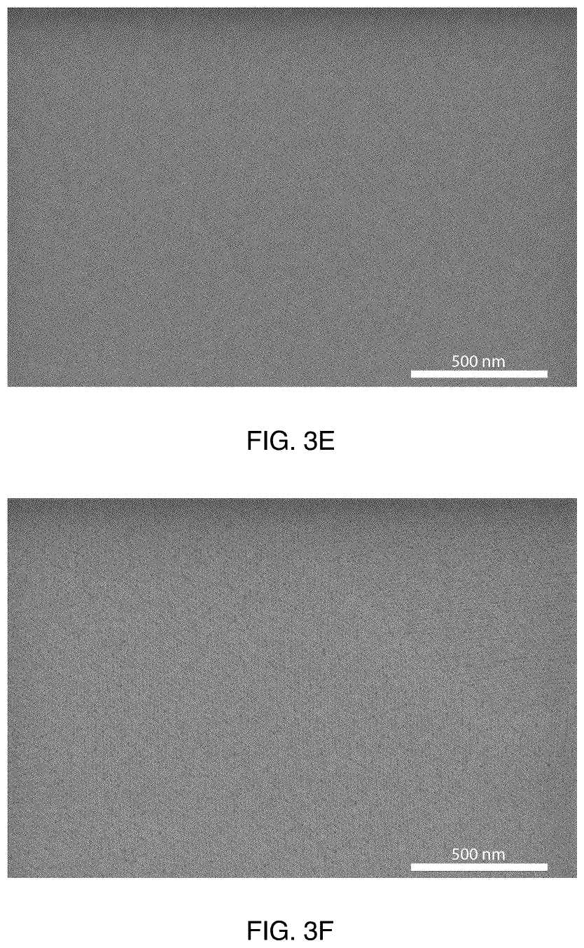

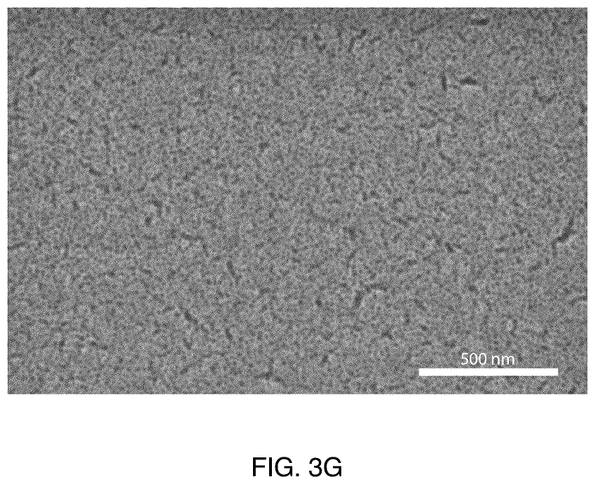

FIG. 3A shows TGA and FIG. 3B shows DSC of the precursor with and without ammonia showing no rapid combustion event and corresponding exotherm in precursor with ammonia. FIG. 3C shows absorbance of the NO₃ at 1348 cm⁻¹ from the aluminum nitrate with increasing cure temperature. FIG. 3D shows absorbance of the C—O stretch at 1105 cm⁻¹ in Pluronic® F127 with increasing cure temperature. FIGS. 3E and 3F are SEM images showing highly ordered pore surface structures with 0 and 0.28 molar ratio of ammonia to Al³⁺, respectively, and the result of FIG. 3G at 0.56 molar ratio of ammonia to Al³⁺ shows disordered surface porosity.

The addition of ammonia to solution combustion reaction precursors has previously been shown to improve combustion efficiency, although this has been explained as an increase in pH driving the deprotonation and subsequent co-ordination of carboxylic acid or acetylacetonate fuels. The reaction of the same precursor compositions is studied for the thin film PIRO. As the mass of the thin film is too small for standard TGA and DSC techniques the reaction is investigated ex situ through FTIR spectroscopy of the films after curing for 1 min at increasing hotplate temperatures for precursors without FIG. 3A) and with FIG. 3B) ammonia added.

IR spectroscopy of the dried, but unreacted, film shows split peaks at 1430 cm⁻¹ and 1348 cm⁻¹ which is assigned to the degenerate ν₃ mode of the nitrate coordinated to the Al³⁺.

Previous studies have demonstrated that the splitting of the ν₃ mode is associated with coordinated nitrate. The other prominent peak of interest is the stretch mode of the C—O—C group at 1105 cm⁻¹ associated with PEO in the Pluronic® F127. At a set hotplate temperature of 200° C. a sudden loss is observed in C—O—C (FIG. 3C) consistent with sudden oxidation of the Pluronic® within the thin film. The loss of the Pluronic® at 200° C. is lower than what is observed in TGA for Pluronic® F127. Tracking the intensity of the nitrate absorption at 1348 cm⁻¹ shows a gradual loss of nitrate with increasing cure temperature up until 200° C. (FIG. 3D). Al(NO₃)₃·9H₂O is known to degrade at elevated temperatures, and so a loss of nitrate species in the reacted film is not surprising, but highlights that a successful combustion reaction requires a rapid increase in temperature to the ignition temperature to prevent precursor degradation.

### B2) Structural Analysis of Films With Ligands of Increasing Acidity

Films made from just Pluronic® F127 and aluminum nitrate are not fully ordered through the thickness of the film. SEM and ellipsometry analysis suggest an ˜80 nm thick ordered layer with on the top surface and the remaining film is a randomly distributed network of spherical pores. Investigations conducted into each aspect of the precursor solution and deposition process showed that the film structure was relatively insensitive to changes in H₂O content, time spent at room temperature before drying, among other variables. As a result, it is anticipated that the incomplete ordering is a thermodynamic limitation and not a kinetic limitation.

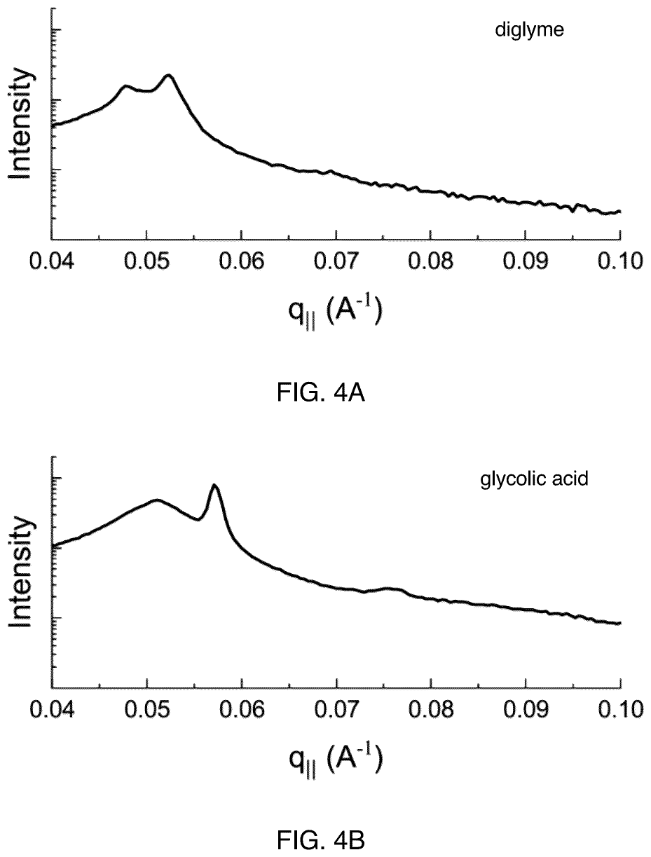

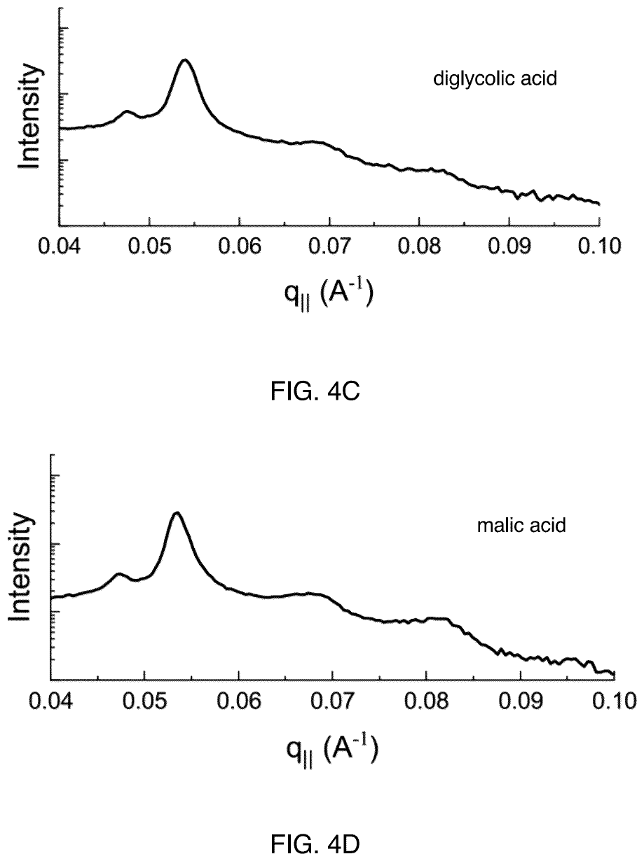

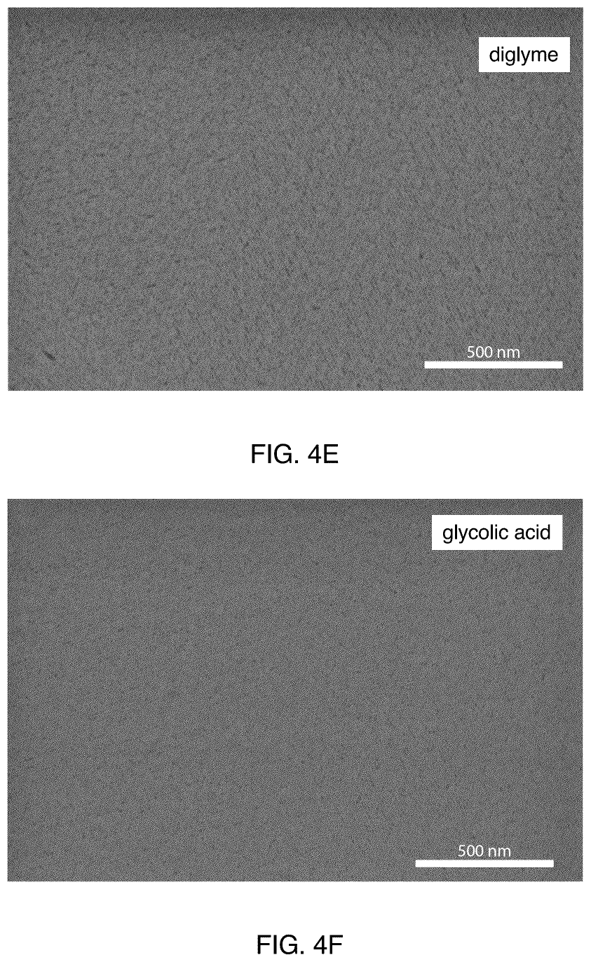

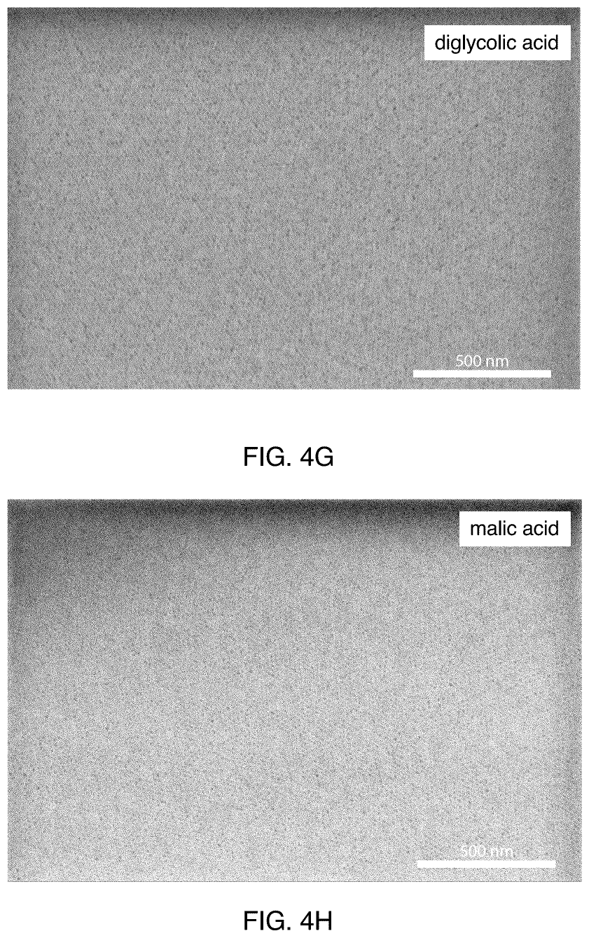

FIGS. 4A, 4B, 4C, 4D show grazing incidence small angle X-ray scattering (GISAXS) of thin films generated with diglyme, glycolic acid, diglycolic acid, and malic acid, respectively, showing differences in the degree of ordering in the bulk of the film based on the presence of more acidic hydrogen bonding moieties in the small molecule organic ligand. FIGS. 4E, 4F, 4G, 4H are SEM images of the surfaces of films generated with diglyme, glycolic acid, diglycolic acid, and malic acid showing comparable surface ordering.

To investigate the inclusion of additional small-molecule organic ligands and their impact on film structure, GISAXS and SEM were used to study ligands with and without carboxylic acid moieties. Diglyme, (FIGS. 4A, 4E) Glycolic acid, (FIGS. 4B, 4F) Diglycolic acid, (FIGS. 4C, 4G) and Malic acid (FIGS. 4D, 4H) were added to precursor solutions before deposition and curing. All ligands were added in equivalent molar amounts except for glycolic acid for which double the molar amount was added. This was so that the glycolic acid, diglycolic acid, and malic acid had equivalent molar amounts of carboxylic acid moieties.

The transition from a mixed film with random porosity and ordered porosity to a film with completely ordered porosity can be explained based on the strength of the hydrogen bonding between the Al³⁺ complexes and the PEO. Previous models of the self-assembly of silica sols with amphiphilic surfactants such Pluronic® highlight the hydrogen bonding between the acidic silanol groups and the ether oxygen of the PEO. Silanol groups are uniquely acidic among common metal hydroxides. Introducing carboxylic acid ligands improves the hydrogen bonding strength between the Al³⁺ complexes and the Pluronic® and encourages the formation of ordered mesoporous thin films comprising a single space group.

Comparison between films made with glycolic acid and diglycolic acid demonstrate that a ligand must be able to coordinate the Al³⁺ cation and have a free carboxylic acid group for hydrogen bonding. (FIG. 1C)

Glycolic acid, which is a ligand with a single carbonyl group, is not effective for producing an ordered structure. Diglycolic acid however, can coordinate to Al³⁺ through one of the carboxylic acid groups and the ether oxygen, leaving a free carboxylic acid group for hydrogen bonding. Malic acid similarly results in an ordered film structure; however, film morphology suffers from the ability of malic acid to form complexes with reduced solubility in ethanol. These low-solubility, larger metal ligand complexes result in substantial film defects that are not observed in the ordered films formed with diglycolic acid.

Finally, the pKa of glycolic acid, diglycolic acid, and malic acid are all relatively comparable and similar to the native pH of the Al(NO₃)₃·9H₂O in ethanol, suggesting that changes in the structure can't be the result of changes in pH.

### B3) Large-Area Manufacturing Capability

A limiting factor for many previous approaches to manufacturing large-area metal oxide thin films is their incompatibility with roll-to-roll processing techniques and flexible substrates due to their environmental sensitivity, aggressive formulations, and the extended curing and sintering steps at high temperatures required. Here, we demonstrate the PIRO deposition and curing steps with roll-to-roll compatible processing techniques.

For deposition, both blade coating and ultrasonic spray deposition were tested. Blade coating, a technique used ubiquitously in thin film manufacturing especially for energy storage and batteries, uses a steel blade coated with nonpolar Teflon to generate a meniscus between the solution and the substrate and gradually deposit high quality films. Ultrasonic spray coating uses a vibrating nozzle at 2 W and 120 KHz to aerosolize droplets of the precursor into a mist that can be quickly deposited into conformal coatings.

The deposited films can then be cured by various scalable curing techniques including via near infrared (NIR) flash curing. NIR curing lamps leverage tungsten emitters to generate a black body radiation profile with peak emission at approximately 900 nm. The Adphos system generates intense infrared along with high wavelength visible light. The NIR system was tested on strong IR absorbing substrates (Si and aluminized PI), and less IR absorbing (fused silica). Aluminum coatings were used on the polymer substrates for multiple reasons: metals strongly absorb infrared radiation allowing for rapid and efficient conversion of light to heat, the aluminum surface is highly polar and complementary to our solution chemistry, and metal thin films can act as electrodes when integrating these mesoporous oxides into functional electronic devices.

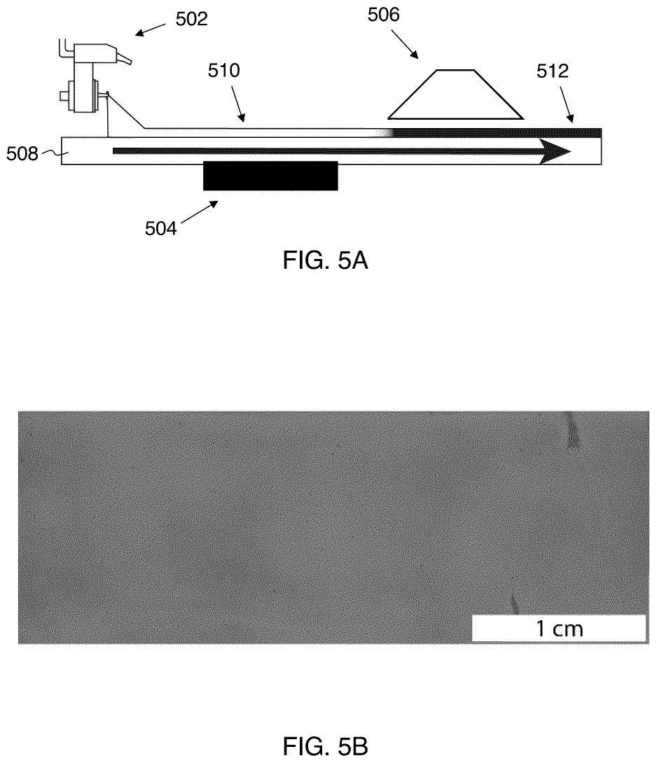

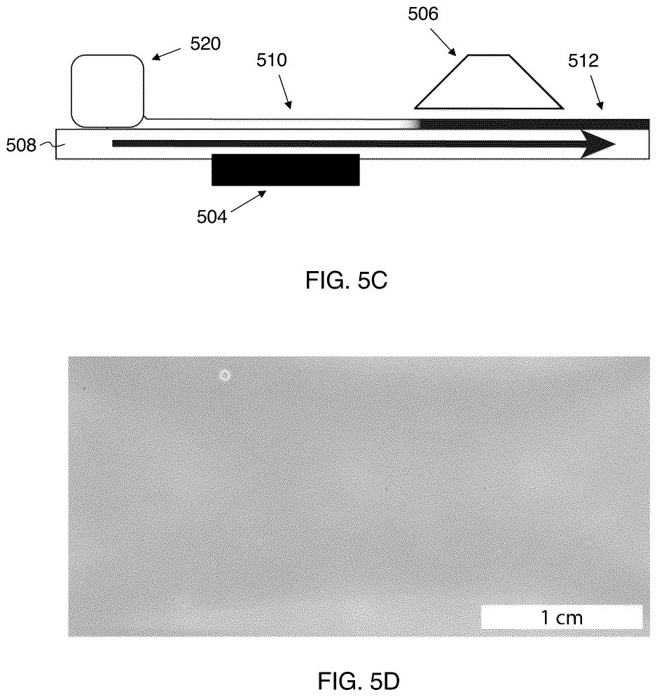

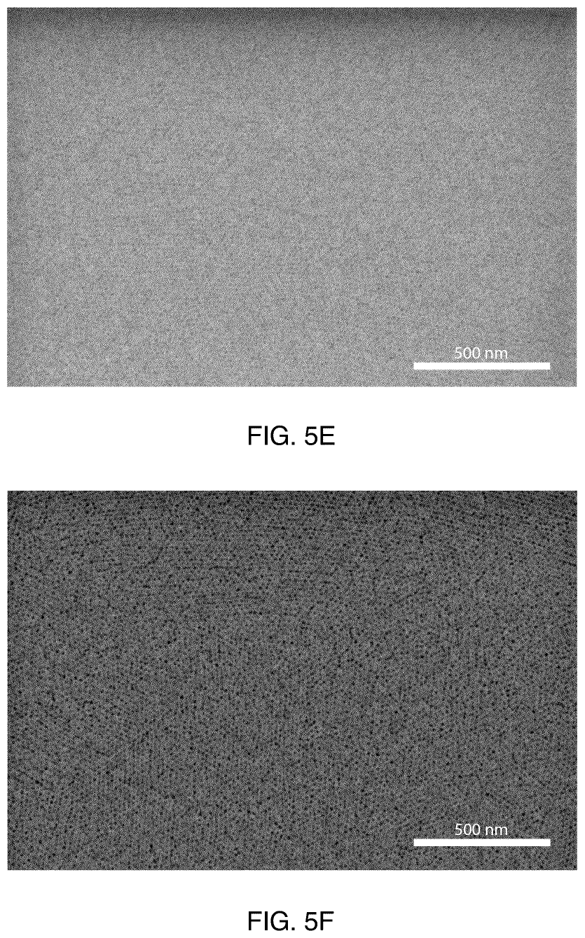

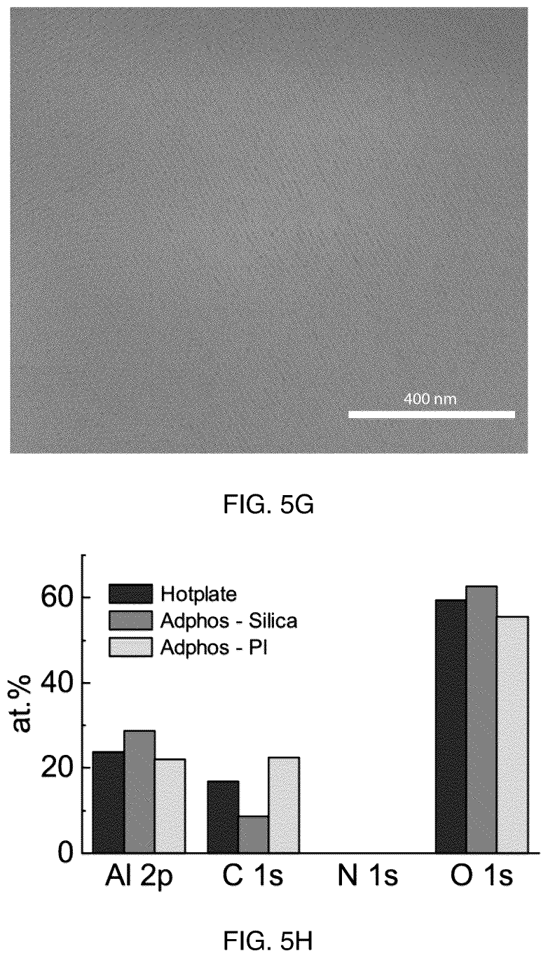

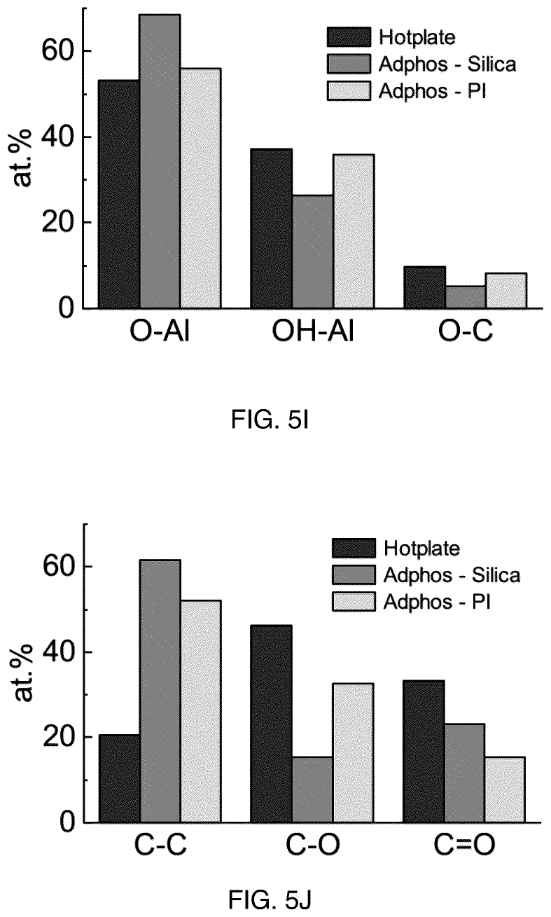

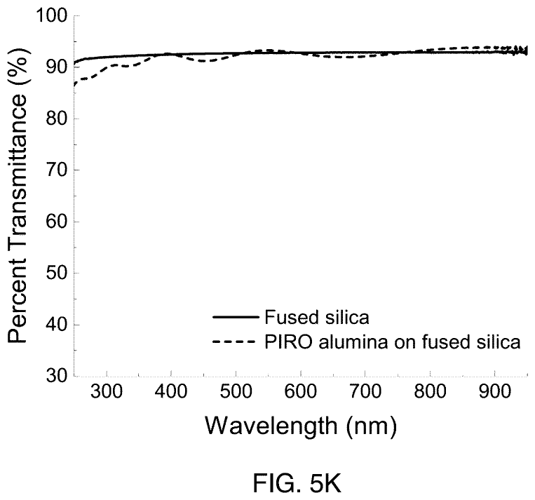

FIG. 5A is a schematic of the preferred embodiment generating films via ultrasonic spray followed by near-infrared flash annealing. Here 502 is the spray nozzle for deposition, 504 is an optional heater, 506 is the flash annealing unit, 508 is the substrate, 510 is the deposited solution and 512 is the porous metal oxide. Relative motion is as indicated by the arrow, substrate 508 moving to the right with respect to nozzle 502 and annealer 506. FIG. 5B is an optical image of a porous metal oxide film generated by ultrasonic spray. FIG. 5C is a schematic of the preferred embodiment generating films via blade coating followed by near-infrared flash annealing. Here 520 is the doctor blade deposition unit and the other components are as indicated above. FIG. 5D is an optical image of a film generated by blade coating.

FIG. 5E is an SEM image of a film doctor bladed onto silicon and hot plate cured. FIG. 5F is an SEM image of a film doctor bladed onto silicon and cured via a NIR flash anneal. FIG. 5G is an SEM image of a film doctor bladed onto aluminized PI (polyimide) and cured via a NIR flash anneal. FIG. 5H shows XPS (x-ray photoelectron spectroscopy) results of thin films generated on silicon wafer with hotplate curing, fused silica with near-infrared curing, polyimide with 50 nm aluminum metal showing Al 2p, C 1s, N 1s, O 1s. FIG. 5I is high-resolution analysis of 1s oxygen bonding in the results of FIG. 5H. FIG. 5J is high-resolution analysis of carbon 1s bonding in the results of FIG. 5H. FIG. 5K shows UV/Vis spectroscopy of blade coated and near-infrared cured porous alumina on fused silica substrate.

Examples of the proposed inline processing steps are shown for ultrasonic spray deposition (FIGS. 5A-B) and blade coating (FIGS. 5C-D). Examples of the PIRO films after curing are shown in FIGS. 5E, 5F, 5G for blade coating. These films exhibit large area uniformity and suggest PIRO is a promising candidate for deposition of the porous films at scale.

To investigate the efficacy of the NIR curing, XPS was conducted to examine the elemental composition (FIG. 5H), O Is peak components (FIG. 5I), and C 1s peak components (FIG. 5J) of films cured via NIR on fused silica and polyimide (PI) substrates.

Films cured with NIR in just one minute at a 1-2 cm working distance show either improved or comparable curing than films cured on the hotplate, with NIR cured films on Silica demonstrating a lower carbon content and a higher atomic concentration of Al—O bonds based on the O 1s peak analysis. Additional SEM on hotplate and NIR cured films deposited by blade coating show that both the hotplate cured (FIG. 5E) and NIR cured films (FIG. 5F) demonstrate well defined, ordered pore structure. Similarly, PIRO films were successfully deposited and cured on PI metallized with 50 nm of aluminum. (FIGS. 5G, 5K) The compatibility of the PIRO reaction with flexible substrates opens a wide range of possible applications.

UV-Vis spectroscopy of the PIRO films (FIG. 5K) demonstrates the excellent optical clarity with less than 1% transmission loss in the visible spectrum compared to a blank fused silica substrate.

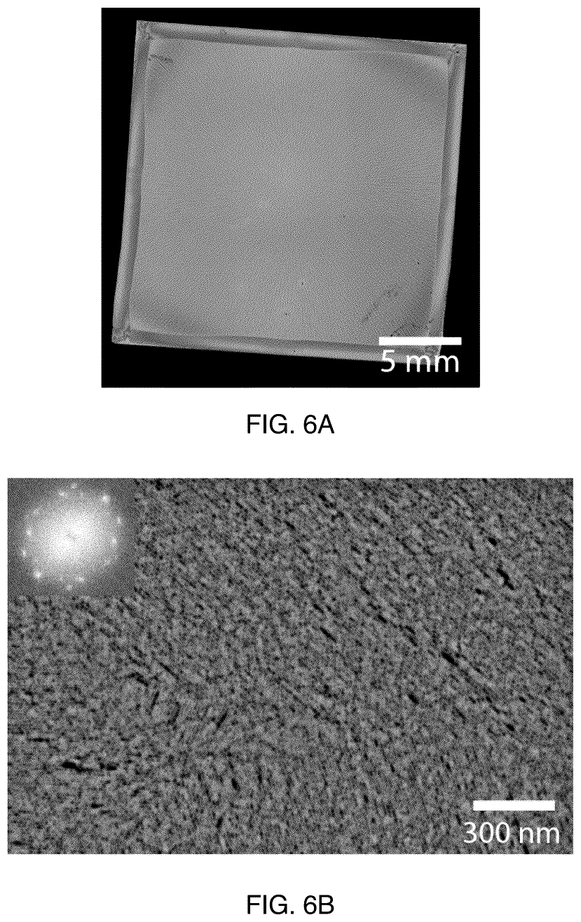

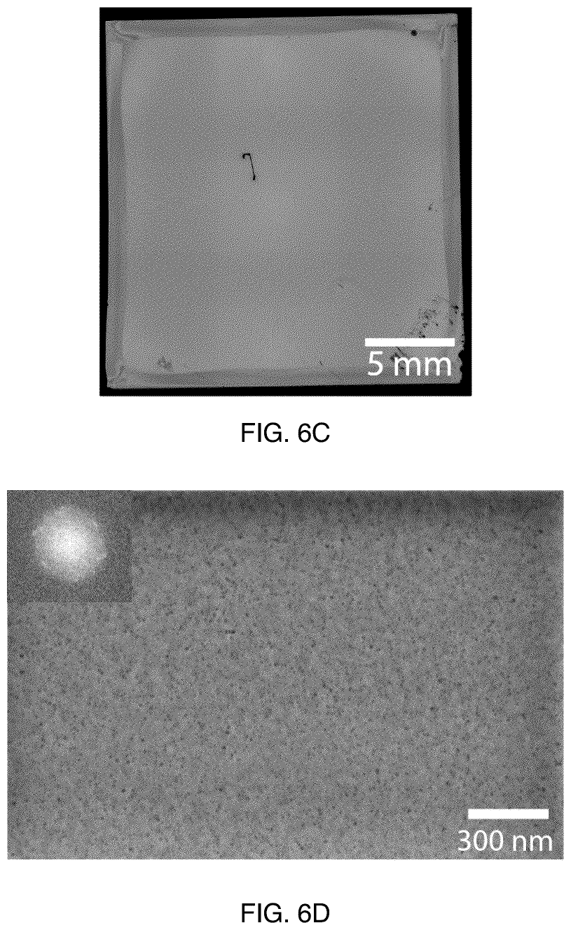

FIG. 6A is an optical image of a spin coated thin film of porous nickel oxide. FIG. 3B is a corresponding SEM image with fast Fourier transform (inset) of porous nickel oxide showing surface ordering.

FIG. 6C is an optical image of a spin coated thin film of porous zinc oxide. FIG. 6D is a corresponding SEM image with fast Fourier transform (inset) of porous zinc oxide.

### B4) Conclusions

An approach we have termed PIRO (porogen integrated rapid oxidation) utilizes solution combustion synthesis along with micelle-forming block co-polymers to successfully deposit and cure films of Aluminum Oxide with structured porosity up to 500 nm thick. The success of PIRO is the result of the coordination chemistry between the aluminum cation and the chelating properties of the hydrophilic polyethylene oxide segment of the polymer inhibiting premature hydrolysis and enabling the rapid oxidation of the polymer. Further the inclusion of an additional organic ligand can act as a structuring agent, allowing repeatable and controllable tuning of the pore structure. We also demonstrate the scalable manufacturing of alumina via PIRO on a variety of substrates at linear processing speeds of up to 6 m/min and with a 1 minute cure time using NIR flash annealing. The result is an over 95% reduction in processing time relative to conventional sol-gel processes from days to less than 1.5 hours. In summary, this study outlines the complete process for the scalable deposition of highly uniform, structured mesoporous aluminum oxide thin films. With modification of the choice of structuring ligands and polymer, we anticipate being able to extend PIRO to a range of transition metal, rare earth and mixed metal oxides to rapidly expand the library of structured, mesoporous, metal oxides that can be deposited quickly and at scale. We anticipate the PIRO will enable uptake of these films in a wide range of applications including optoelectronics, thin film catalysis, and energy storage.

### B5) Methods

### Materials

Aluminum nitrate nonahydrate (98%+, ACS grade), Pluronic® F127, aqueous ammonium hydroxide (30-33%, puriss.), anhydrous ethanol (absolute, 200 proof), diglyme, diglycolic acid, malic acid, and citric acid were purchased from Sigma Aldrich and were used as received. Acetone (HPLC grade) and IPA (HPLC grade) were purchased from Fisher Scientific and used as received.

For conventional deposition, single-sided polished silicon wafer and soda-lime glass were cleaned by first scrubbing with 1% Alconox solution and rinsed in DI water. Substrates were then ultrasonicated in acetone for 10 min, followed by ultrasonication in IPA for another 10 min. Finally, substrates were then treated under UV/Ozone for 15 min and used immediately.

### Synthesis

To prepare solutions for PIRO, aluminum nitrate nonahydrate was dissolved into absolute anhydrous ethanol. Pluronic® F127 was then added to the aluminum nitrate sock and allowed to dissolve under stirring. Next, ammonia was diluted in ethanol and slowly added dripwise under strong stirring to the solution containing the aluminum nitrate and Pluronic® F127. Small white wisps will form in the solution and should immediately redissolve during base addition. The solution was then allowed to react under gentle stirring overnight at 60° C. in a sand bath. After overnight heating, the solution is pale yellow. The appropriate complexing co-fuel small molecule (e.g., diglyme, diglycolic acid, etc.) is then added and the solution is allowed to stir for another 2 hours at 60° C. Solutions are observed to be shelf stable.

For conventional deposition and curing, films were spin coated at 2000 rpm with a 500 rpm/sec acceleration for 20 s onto silicon or soda-lime glass substrates. Following spin coating, films were left at ambient conditions for 15 min for self-assembly to occur and then transferred to an oven at 70° C. to dry for up to 1 hr. The films were then combusted by placing the dried films onto a preheated Wenesco high uniformity hotplate at 230° C. for up to 30 minutes. The combustion process is generally accompanied by a puff of white smoke and a rapid change in index of refraction observable as a rapid color change in the oxidized films. After curing, the films are stored in an air-free glove box or under vacuum desiccation until characterization.

Blade coating was performed using an MSI four-sided stainless-steel blade coater using an automatic, programmable gantry system. The substrate was placed on a smooth glass substrate. Solution was deposited to pre-form the meniscus at the leading edge of the substrate and then the blade moved across the substrate at a variable programmed speed up to 1 cm/sec.

Ultrasonic spray was also used as a scalable technique to form self-assembled films. The stock solution described above was diluted 10 times in absolute anhydrous ethanol and sprayed at up to 6 m/min with a single pass speed over the substrate from a SonoTek Impact nozzle and with a nitrogen shaping gas flow.

Films from both blade and spray coating were then allowed to self-assemble for 15 minutes followed by 1 hour of drying in a 70° C. oven. A longer drying step for these larger area, thicker films was found to be preferable for ensuring proper combustion and subsequent morphology.

An Adphos near-IR curing system was also employed to initiate combustion in the thin films. Curing as performed using an Adphos NIR 50-50 with two tungsten emitters at 1 cm height from the substrate for 1 minute at 100% power. The substrates were air-gapped to isolate heating from the NIR emitters to the absorbance from the solution and substrate.

### C) APPLICATION TO CAPACITOR DIELECTRICS

Nanolayered capacitors with small form factors (<5 μm thickness) with much higher energy recovery and density are a pivotal technology to bridge the gap between existing energy storage and next-generation batteries and capacitors. Nanolayered metal oxide porous films with ordered, interconnected nanoscale porosity are ideal candidates for such nanolayered capacitors serving as scaffolds for polymer dielectrics while retaining excellent mechanical properties due to the strength and stiffness of the interconnected oxide. The resulting metal oxide-polymer composite nanolayer can be fabricated into capacitors with precisely controlled polymer volume fraction and distribution, film thickness and surface morphology, along with selected combinations of high dielectric constant and breakdown voltage.

Metal oxide ceramic capacitors have very high dielectric constants (k>10) but struggle from intrinsic instabilities against breakdown (both electronic and mechanical failure) including via mechanical fracture due to their brittleness. Polymers, on the other hand, struggle from often low dielectric constants but maintain impressive breakdown voltages. Additionally, polymers with their low elastic moduli can “self-heal” within capacitors to inhibit the mechanical failure mechanisms that give rise to device shorting. As a result, composite polymer-oxide capacitors have been developed to benefit from the dielectric properties of a metal oxide filler and a matrix of polymer for dielectric breakdown strength. There has been considerable development of nanocomposites requiring nanoparticle synthesis with control over the nanoparticle morphology and the surface of the nanoparticles to generate impressive capacitances. However, critical challenges remain with nanocomposite devices including phase segregation of the nanoparticles within the polymer matrix and the intrinsic challenges associated with forming stable chemical modifications of surfaces.

Currently the fabrication of these nanolayered dielectrics is limited to lab scale by their synthesis including sol-gel which suffers from intrinsically unstable and expensive precursors, sensitivity to humidity, and unacceptably low-throughputs on the order of multiple hours to days. As a result, nanolayered oxide-polymer capacitors are not suitable for scalable high-volume manufacturing.

In this work, we consider forming thin film nanocapacitors through scalable fabrication of a metal oxide matrix via the above-described PIRO technology as the fixed oxide inorganic phase and a flowable fill polymer or precursor monomer infiltrated into the oxide matrix. The resulting oxide scaffold is then filled with dielectric polymer and capped with a top electrode to form a nanolayered hybrid capacitor.

Within the porous structure, the polymers can exhibit unique behaviors and impressive dielectric properties in conjunction with the nano-metal oxide frame work. In the preferred embodiment of porous aluminum oxide and a dielectric cyclo-olefin co-polymer, a dielectric constant of >6 at 1 KHz is demonstrated. Moreover, the fill polymer chemistry can be easily tuned to give an array of dielectric properties including by filling with high temperature polymers such polyimide, and electrolytic polymers like poly(3,4-ethylenedioxythiophene) polystyrene sulfonate (PEDOT:PSS). This innovation is enabled by the presence of a highly ordered, open-cell porous matrix from PIRO which has controllable pore sizes <20 nm and thus generates confinement effects in the polymers leading to unique polymer structures and dynamics. The small pore radius means that capillary forces allow direct filling of polymers or monomer precursors when the polymer or monomer is deposited onto the top surface of the porous matrix. To encourage infiltration the polymers can be solvated or thermally annealed. Nanocomposites can also be manufactured by first diffusing a monomer precursor into the porous matrix and allowing the monomer to react in-situ. The reaction can then progress to form the desired final polymer molecular weight or form a cross-linked network. Starting with a precursor monomer means that the diffusing species is much more mobile at room temperature, reducing the processing time and heating requirements for infiltration.

Before filling the porous matrix, the oxide surface can be functionalized with a variety of chemical species such as silane and phosphonic acid derivatives. As such, the surface chemistry of the oxide matrix can be tailored to engineer improved dielectric performance without having to consider the impact on particle dispersion that plagues conventional nanoparticle-based composites.

Significant advantages are provided. Competing technology is mainly thin film capacitors that are either homogenous layers of oxide and polymer, all-polymer, or contain particles of oxide. Our method is fully unique as a completely interconnected, ordered oxide matrix that is then filled with a polymer for use in a thin film capacitor application. More detailed consideration of some of these advantages follows.
1) Compatibility with other in-line process operations and underlying film/substrate integration: Our PIRO manufacturing combines the processing technology developed for sol-gel and other wet chemistries with open-air in-line ultrasonic spray and remarkably low annealing temperatures to rapidly form and process nanolayered capacitor films. These open-air processes have high throughput and are inherently scalable compared to current evaporation-based thin-film processing. In addition, we can integrate other in-line process operations like rapid thermal annealing (RTA) to optimize reaction speed, film quality and morphology, and resulting electrical and breakdown properties. Furthermore, PIRO enables nanolayered capacitor processing directly onto flexible polymer substrates that are sensitive to high temperature processing needed for conventional annealing. This is because of the high-speed fabrication and controllable thermal budget associated with the PIRO operation. We can scale large in-plane cell-level structures to demonstrate the film efficacy, cycling lifetime, conductivity, and degradation rates across a variety of temperatures and cycling conditions.
2) Optimizing energy density with breakthrough concepts using nanocomposite dielectric layers: The energy density of dielectric capacitors is directly proportional to the product of the nanolayer dielectric constant, εᵣ, and the square of the electric field, E². Approaches to enabling the application of small form factor nanolayer dielectric capacitors requires improving the stored energy density by enhancing both εᵣ and E which is limited by the electric field breakdown strength, E_{B}, of the dielectric layer itself. While both polymer and metal oxide dielectric layers can be employed, polymers have high breakdown strength but suffer from low dielectric constants and metal oxides exhibit high dielectric constants but suffer from low breakdown strengths. Furthermore, polymers have the advantage of “self-healing” properties of molecular level defects related to incipient dielectric breakdown, while ceramic metal oxide layers have the disadvantage of being more expensive and mechanically brittle thus prone to cracking in-service. Creating nanocomposite dielectric layers by introducing metal oxide nanofillers such as TiO₂, SiO₂, or Al₂O₃ nanoparticles into a polymer matrix have been used to take advantage of the properties of the constituent polymer and metal oxide phases but success has been limited by frustrating tradeoffs between improved Er of the polymer nanocomposite layer at the expense of breakdown strength EB, segregation of the nanofillers, poor control of nanofiller particle size distribution and interfacial chemistry with the matrix, and implementation for small form factor nanolayers. Assembling nanofillers in preferred orientations has also been attempted to achieve higher dielectric constant and breakdown strengths, but again similar challenges exist and scalable fabrication to produce the ordered fillers is not available. Finally, other strategies involving composite multilayer oxide or polymer nanolayered capacitors involving, e.g. atomic layer deposited alumina and zirconia layers, or different polymer films requiring long drying times and high pressures for hot compression molding are also not feasible for commercial purposes.

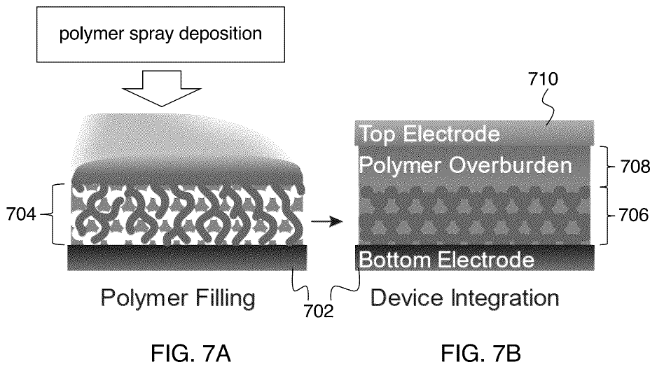

FIGS. 7A-B schematically show an application of the above-described porogen integrated rapid oxidation (PIRO) process for making improved capacitor dielectrics. FIG. 7A shows polymer infiltration (e.g., via spray deposition) into a porous metal-oxide layer 704 on substrate 702. FIG. 7B shows the result of further processing to form a capacitor having top electrode 710, a bottom electrode provided by substrate 702, and polymer-filled porous layer 706. Optionally, there can also be a polymer layer 708 between polymer-filled porous layer 706 and top electrode 710.

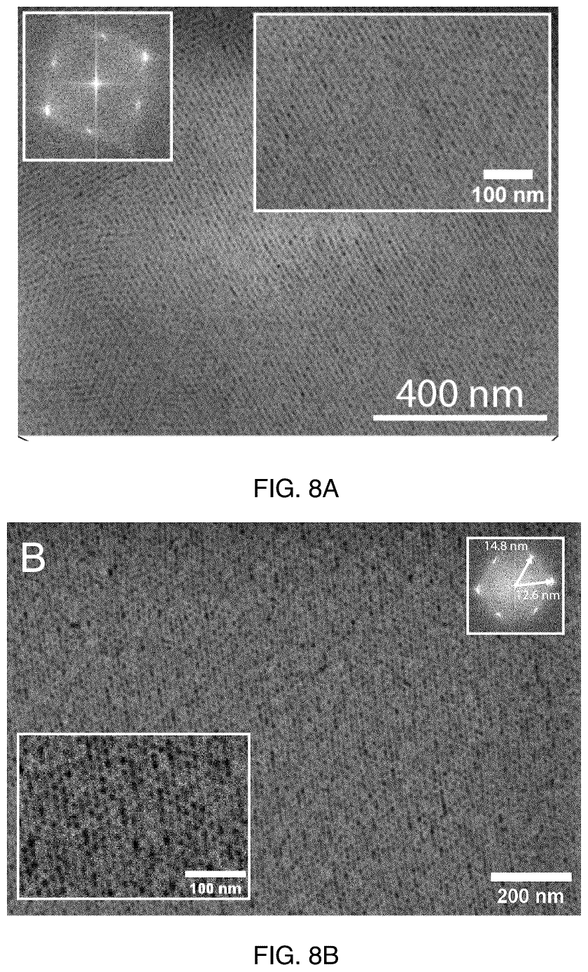

FIG. 8A is an SEM image with both FFT (fast Fourier transform) and zoom insets of pore structure for PIRO films doctor bladed onto aluminized PI (polyimide) and combusted via a NIR (near infrared) flash anneal. FIG. 8B is a representative SEM of a 450 nm thick film surface with diglycolic acid included as a co-fuel at a 0.2 diglycolic acid/Al³⁺ molar ratio. Insets: FFT highlighting the strong periodicity of the pore structure and an SEM close-up of the film's ordered structure. In both these examples, the FFT results show significant periodicity of the pores.

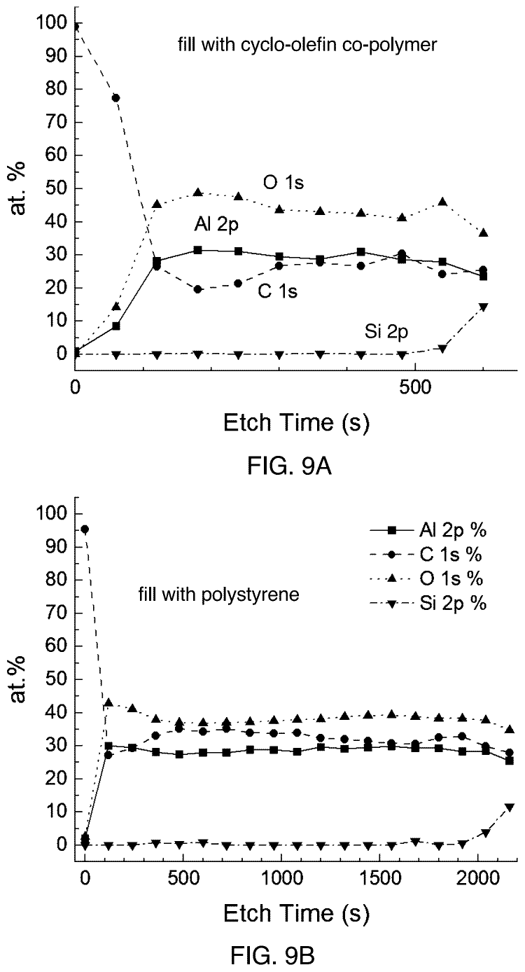

FIGS. 9A-B show XPS-Ar+ depth profiles of dielectric polymer nanocomposites made with PIRO aluminum oxide thin films showing homogenous and complete filling of a cyclo-olefin co-polymer and polystyrene, respectively.

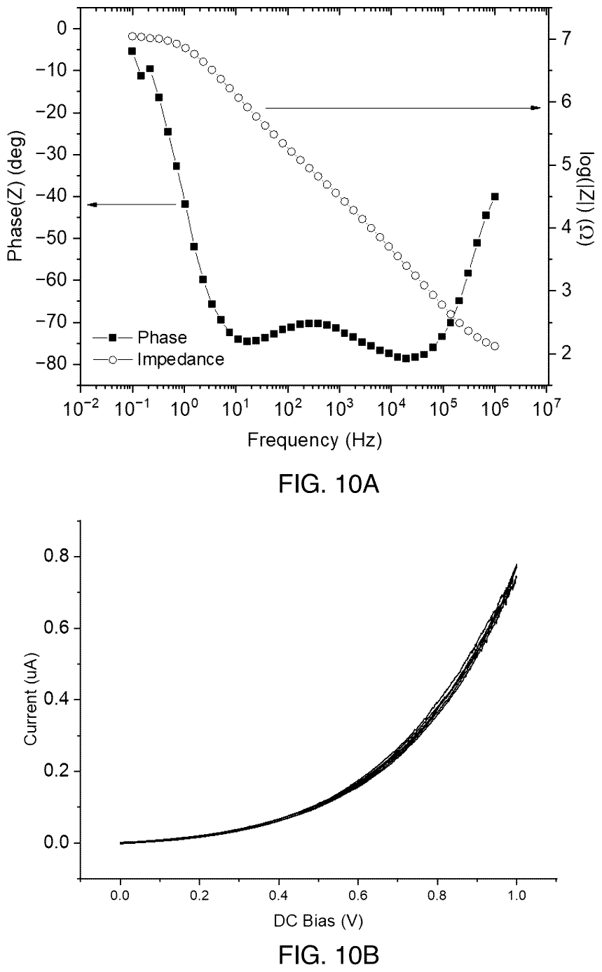

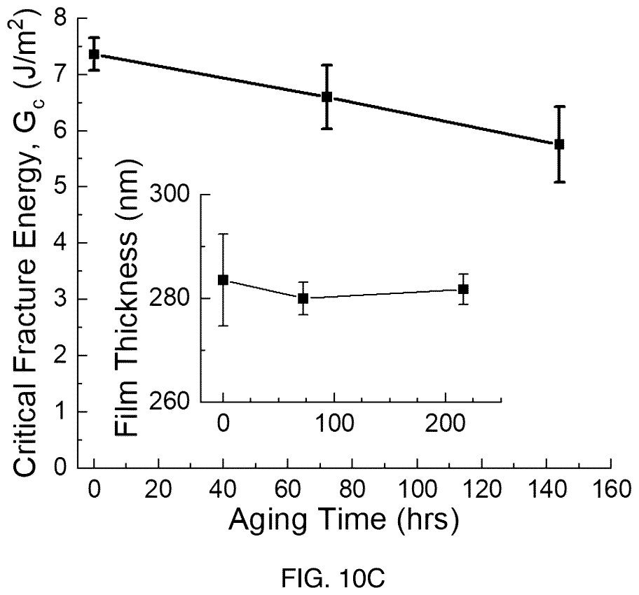

FIG. 10A shows dielectric spectroscopy of a cyclo-olefin co-polymer and PIRO aluminum oxide nanocomposite dielectric. FIG. 10B shows current voltage scan of a cyclo-olefin co-polymer and PIRO aluminum oxide showing capacitive behavior. FIG. 10C shows cohesive fracture energy of an aluminum oxide and cross-linked polyimide nanocomposite after aging at 325° C. for up to 140 hrs. Here the inset shows nanocomposite film thickness during the aging process.

1. A method of making a capacitor dielectric, the method comprising:
depositing a solution onto a substrate to provide a deposited layer, wherein the solution includes a nonvolatile oxidizing reagent, a porogen, and one or more metal ion complexes of one or more metallic species;
aging the deposited layer to perform self-assembly in the deposited layer, wherein the structured, self-assembled layer is generated having a structure determined in part by the porogen;
oxidizing the structured, self-assembled layer to form a porous metal oxide layer via a rapid, local, exothermic oxidation reaction that provides decomposition of the porogen;
wherein pores of the porous metal oxide layer are formed by decomposition of the porogen in the oxidizing step, wherein the porous metal oxide layer has a pore structure corresponding to the structure of the structured self-assembled layer; and
forming a polymer in pores of the porous metal oxide layer to make the capacitor dielectric.

2. The method of claim 1, wherein the forming a polymer comprises infiltrating the polymer into the pores of the porous metal oxide layer.

3. The method of claim 1, wherein the forming a polymer comprises infiltrating one or more small-molecule precursor species into the pores of the porous metal oxide layer and then polymerizing and/or cross linking the one or more small-molecule precursor species to form the polymer.

4. The method of claim 1, further comprising functionalizing the pores of the porous metal oxide layer before the forming a polymer in pores of the porous metal oxide layer.

5. The method of claim 4, wherein the functionalizing the pores of the porous metal oxide layer comprises a method selected from the group consisting of: exposure to chlorosilanes, exposure to alkoxysilanes, exposure to phosphonic acid, and exposure to phosphonic acid derivatives.

6. The method of claim 1, wherein the porous metal oxide layer includes one or more materials selected from the group consisting of: Aluminum oxide, Zirconium oxide, Lanthanum oxide, Barium oxide, Titanium oxide, Cerium oxide, Hafnium oxide, Aluminum hydroxide, Zirconium hydroxide, Lanthanum hydroxide, Barium hydroxide, Titanium hydroxide, Cerium hydroxide, Hafnium hydroxide, and mixtures thereof.

7. The method of claim 1, wherein the polymer is selected from the group consisting of: cyclo-olefin co-polymers, polyimides, polyetherimides, polystyrenes, and polypropylenes.

8. The method of claim 1, wherein a pore diameter of the porous metal oxide layer is 30 nm or less.

9. The method of claim 1, wherein a dielectric constant of the capacitor dielectric is 4 or more at 1 KHz.

10. The method of claim 1, wherein a breakdown field of the Capacitor dielectric is 10 V/μm or more.

11. The method of claim 1, wherein a dielectric loss of the capacitor dielectric is below 0.06.

12. The method of claim 1, wherein the capacitor dielectric possesses a cohesive fracture energy of at least 2 J/m².

13. The method of claim 1, further comprising forming a polymer layer on top of the porous metal oxide layer, whereby the capacitor dielectric includes a polymer-filled porous metal oxide layer and the polymer layer.

14. The method of claim 1, further comprising disposing two capacitor electrodes that sandwich the capacitor dielectric to form a capacitor.
